(19) United States
(12) Patent Application Publication
(10) Pub. No.: US 2021/0354394 A1
(43) Pub. Date: Nov. 18, 2021

(54) APPLYING FUSING AGENT TO BUILD MATERIAL

(71) Applicant: HEWLETT-PACKARD DEVELOPMENT COMPANY, L.P., Spring, TX (US)

(72) Inventors: Pol Fornos Martinez, Sant Cugat del Valles (ES); Lucas Saez-Benito, Sant Cugat del Valles (ES); David Ramirez Muela, Sant Cugat del Valles (ES)

(21) Appl. No.: 16/605,533

(22) PCT Filed: Apr. 27, 2018
(86) PCT No.: PCT/US2018/029750

§ 371 Date: Oct. 16, 2019

(51) Int. Cl. B29C 64/393; B29C 64/165; B22F 10/14; B22F 10/85; B33Y 10/00; B33Y 30/00; B33Y 50/02

(52) U.S. Cl. CPC B29C 64/393; B29C 64/165; B22F 10/14; B33Y 50/02; B33Y 10/00; B33Y 30/00; B22F 10/85

(57) ABSTRACT

Example additive manufacturing apparatus is disclosed comprising a print agent distributor, and a controller to define print data for additive manufacture of a solid part of an object to be manufactured, wherein the print data is to cause a print agent distributor to apply fusing agent to portions of a layer of build material, wherein the print data is to cause a print agent distributor to apply fusing agent to portions of a layer of build material at a concentration based on a distance of each portion of build material from an edge of the object such that the print data causes the print agent distributor to apply fusing agent to portions of a layer of build material having a first range of distances at a first range of concentrations, apply fusing agent to portions of build material having a second range of distances at a second range of concentrations lower than the first range of concentrations, apply fusing agent to portions of build material having a third range of distances at the first range of concentrations and apply fusing agent to portions of build material having a fourth range of distances at the second range of concentrations, wherein the first range of distances is not adjacent to the third range of distances and the second range of distances is not adjacent to a fourth range of distances, and the first concentration is different to the second concentration, wherein the print agent distributor is to apply fusing agent to build material based on the print data.

### BACKGROUND

Additive manufacturing techniques such as three-dimensional (3D) printing relate to techniques for making 3D objects of almost any shape from a digital 3D model through additive processes in which 3D objects are generated on a layer-by-layer basis under computer control. A large variety of additive manufacturing technologies have been developed differing in build materials, deposition techniques and processes by which the 3D object is formed from the build material. Such techniques may range from applying ultraviolet light to photopolymer resin, to melting semi-crystalline thermoplastic materials in powder form, to electron-beam melting of metal powders.

Additive manufacturing processes may begin with a digital representation of a 3D object or objects to be manufactured, This digital representation may be virtually sliced into layers by computer software or may be provided in pre-sliced format,. Each layer represents a cross-section of the objects to be manufactured, and is sent to an additive manufacturing apparatus (also termed a “3D printer”) where the object is built upon a previously built layer. This process is repeated until the objects are completed, thereby building the objects layer-by-layer. While some available technologies directly print material, others use a recoating process to form successive layers that can then be selectively solidified in order to create each cross-section of the objects.

The build material from which the object or objects are manufactured may vary depending on the manufacturing technique and may comprise powder material, paste material, slurry material or liquid material. The build material may be provided in a source container from where it needs to be transferred to the building area or building compartment (e,g, chamber) of the additive manufacturing apparatus where the actual manufacturing takes place.

### BRIEF DESCRIPTION OF DRAWINGS

Examples will now be described, by way of non-limiting example, with reference to the accompanying drawings, in which;

FIG. 1 is a simplified schematic of an example of additive manufacturing apparatus;

FIG. 2 is a simplified schematic of an example of a layer of build material;

FIG. 3 is a simplified schematic of an example of additive manufacturing apparatus;

FIG. 4 shows an example of a non-transitory machine-readable medium;

FIG. 5 shows an example of a non-transitory machine-readable medium; and

FIG. 6 is a flow chart of a method of providing instructions for an additive manufacturing apparatus to create a solid part of an article.

### DETAILED DESCRIPTION

Three-dimensional objects can be generated using additive manufacturing techniques. The objects may be generated by solidifying portions of successive layers of build material. In some examples, the build material can be powder-based and the properties of generated objects may be dependent on the type of build material and the type of solidification. In some examples the build material may be formed from, or may include, short fibres that may, for example, have been cut into short lengths from long strands or threads of material. The build material may in some examples include one or more plastics, ceramic, metal powders, and powder-like materials.

In some examples, solidification of the build material is enabled using a liquid solidification agent such as for example a fusing or binding agent. In further examples, solidification may be enabled by temporary application of energy to the build material. In certain examples, fusing and/or binding agents are applied to build material, wherein a fusing agent is a material that, when a suitable amount of energy is applied to a combination of build material and fusing agent, causes the build material to fuse and solidify. In some examples, a detailing agent may be applied to areas containing build material adjacent to an object being created, for example, so as to inhibit solidification of build material in these areas, or in some examples to provide a cooling effect to certain areas of build material. In other examples, other build materials and other methods of solidification may be used. In certain examples, the build material includes paste material, slurry material or liquid material.

According to some examples, a suitable fusing agent may be an ink-type formulation comprising carbon black, such as, for example, the fusing agent formulation commercially known as V1Q600 “HP fusing agent” available from HP Inc. In one example, such a fusing agent may additionally comprise an infra-red light absorber. In one example, such an ink may additionally comprise a near infrared light absorber. In one example, such a fusing agent may additionally comprise a visible light absorber. In one example, such an ink may additionally comprise a UV light absorber. Examples of inks comprising visible light enhancers are dye based colored ink and pigment based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

In one example the build material in the source container is powder that has an average volume-based cross sectional particle diameter size of between approximately 5 and approximately 400 microns, between approximately 10 and approximately 200 microns, between approximately 15 and approximately 120 microns or between approximately 20 and approximately 80 microns. Other examples of suitable, average volume-based particle diameter ranges include approximately 5 to approximately 80, or approximately 5 to approximately 35 microns, In this disclosure a volume-based particle size is the size of a sphere that has the same volume as the powder particle. With “average” it is intended to explain that most of the volume-based particle sizes in the container are of the mentioned size or size range but that the container may also contain particles of diameters outside of the mentioned range. For example, the particle sizes may be chosen to facilitate distributing build material layers having thicknesses of between approximately 10 and approximately 200 microns, or between approximately 10 and approximately 200 microns, or between approximately 15 and approximately 150 microns. One example of an additive manufacturing system may be pre-set to distribute build material layers of approximately 90 microns using build material containers that contain powder having average volume-based particle diameters of between approximately 40 and approximately 60 microns. For example the additive manufacturing apparatus can be reset to distribute different layer thicknesses.

Suitable powder-based build materials for the container of this disclosure include at least one of polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide, thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, multi-color powder, and plastics/ceramics blends.

In some examples of additive manufacturing, it may be the case that build materials become heated. For example, where fusing agents are applied and caused to absorb energy, this heats the build material, in particular in the regions to which fusing agents have been applied. This may result in solidification of portions of build material where the fusing agent has been applied. In addition, some additive manufacturing processes may pre-heat build materials.

The heat absorption properties of a particular build material may in some examples determine performance of an additive manufacturing process. For example, an object being manufactured may have a large solid part, and the large solid part may absorb heat during the manufacturing process. This may in some examples cause the solid part to become deformed and/or cause adjacent regions of build material to fuse, leading to defects.

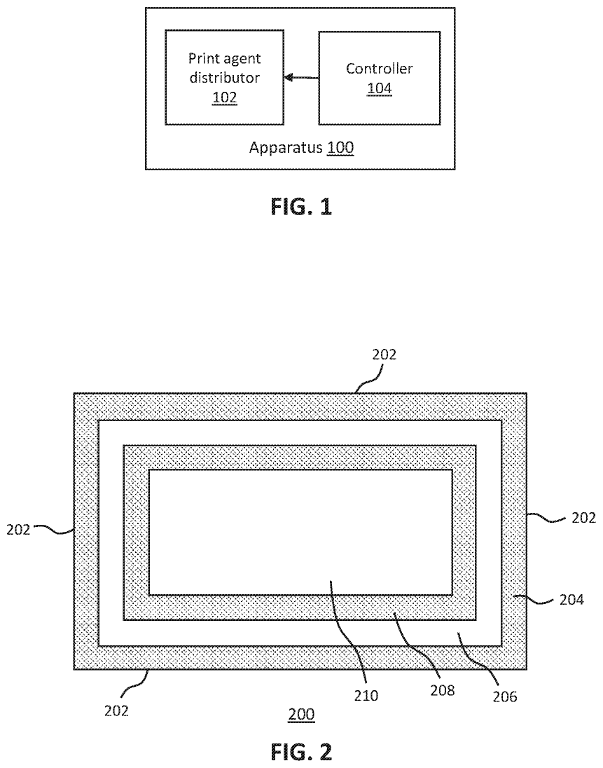

FIG. 1 is a simplified schematic of an example of additive manufacturing apparatus 100. The apparatus 100 comprises a print agent distributor 102 and a controller 104. The controller 104 is to define print data for additive manufacture of a solid part of an object to be manufactured.

The print data is to cause a print agent distributor (e.g. the print agent distributor 102) to apply fusing agent to portions of a layer of build material, wherein the print data is to cause a print agent distributor to apply fusing agent to portions of a layer of build material at a concentration based on a distance of each portion of build material from an edge of the object such that the print data causes the print agent distributor to apply fusing agent to portions of a layer of build material having a first range of distances at a first range of concentrations, apply fusing agent to portions of build material having a second range of distances at a second range of concentrations lower than the first range of concentrations, apply fusing agent to portions of build material having a third range of distances at the first range of concentrations and apply fusing agent to portions of build material having a fourth range of distances at the second range of concentrations. The first range of distances is not adjacent to the third range of distances and the second range of distances is not adjacent to a fourth range of distances, and the first concentration is different to the second concentration.

The print agent distributor 102 is to apply fusing agent to build material based on the print data. In some examples, this causes the print agent distributor to apply fusing agent to portions that tend to form concentric bands, rings or paths that generally follow an edge or perimeter of the solid part of the object. In some examples, when the build material subsequently undergoes a fusing process, the build material having the first, second, third and fourth ranges of distances from an edge of the solid part of the object may be fused to form the solid part of the object. Therefore, even though the second concentration is lower than the first concentration, the fusing agent having the second and fourth ranges of distances may still fuse and be included in the solid part of the object. In some examples, the second range of concentrations is zero, and thus no fusing agent is applied to the build material having second and fourth ranges of distances.

FIG. 2 shows an example of a layer of build material including material that may be fused to be included in a solid part 200 of an object. The solid part 200 of the object may include an edge 202. Portions of a layer of build material having a first range of distances from the edge 202 to which fusing agent may be applied at a first range of concentrations are shown by a first shaded area 204, which generally follows the perimeter 202. Although a layer of build material is shown, the area 204 of build material may in some examples comprise build material in multiple layers of build material. In the example shown in FIG. 2, the first shaded area 204 includes the edge 202 (or perimeter) of the object, though in other examples the first shaded area 204 may not include the edge 202. In some examples, the first shaded area 204, if it includes the edge 202 of the solid part of the object, may be thicker or wider than other areas so as to help preserve edge detail.

In some examples, following a fusing process, the areas 204, 206, 208 and 210 are fused and solidified and form at least a portion of the solid part of the object.

Portions of the layer of build material having a second range of distances from the edge 202 to which fusing agent may be applied at a second range of concentrations are shown by a second area 206. Portions of the layer of build material having the third range of distances from the edge 202 to which fusing agent may be applied at the first range of concentrations are shown by a third shaded area 208. Portions of the layer of build material having the fourth range of distances from the edge 202 to which fusing agent may be applied at the second range of concentrations are shown by a fourth area 210. There may in some examples be additional areas to which fusing agent at the first and/or second concentration is applied, and these additional areas may comprise portions of build material having a range of distances from the edge 202 that is different from the first, second, third and fourth distances. Thus, in some examples, concentric bands, rings or paths tend to be formed, to which alternating first and second ranges of concentrations of fusing agent is applied or to be applied. The rings (and hence the ranges) may have any width, though in some examples, the rings may be of substantially the same width, except in some examples for the outermost range (e.g. the first shaded area 204), which may be thicker or wider to help preserve edge detail. In some examples, similar processes are also applied to different layers of build material to tend to form rings, paths or bands of alternating fusing agent concentrations thereon. In some examples, in a different layer of build material that lies directly above the layer of build material, the concentration of at least one of the regions of build material having a particular range of distances from the edge is changed, e.g. from the first range of concentrations to the second range of concentrations or from the second range of concentrations to the first range of concentrations. This may avoid having an area having the second range of concentrations directly overlying another area in a different layer having the second range of concentrations,

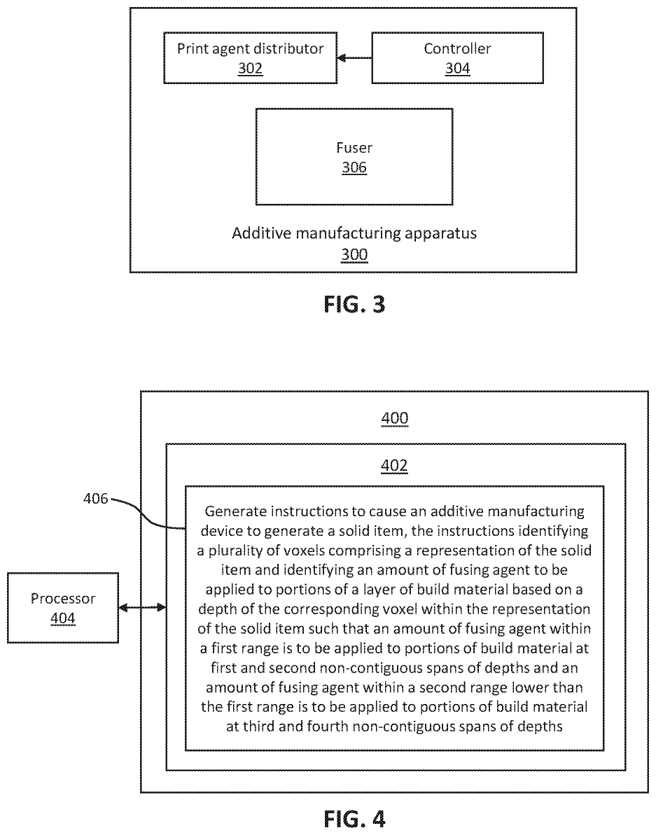

FIG. 3 is a simplified schematic of an example of additive manufacturing apparatus 300. The apparatus 300 comprises a print agent distributor 302 and a controller 304. The controller 304 is to define print data for additive manufacture of a solid part of an object to be manufactured.

The print data is to cause a print agent distributor (e.g. the print agent distributor 302) to apply fusing agent to portions of a layer of build material, wherein the print data is to cause a print agent distributor to apply fusing agent to portions of a layer of build material at a concentration based on a distance of each portion of build material from an edge of the object such that the print data causes the print agent distributor to apply fusing agent to portions of a layer of build material having a first range of distances at a first range of concentrations, apply fusing agent to portions of build material having a second range of distances at a second range of concentrations lower than the first range of concentrations, apply fusing agent to portions of build material having a third range of distances at the first range of concentrations and apply fusing agent to portions of build material having a fourth range of distances at the second range of concentrations. The first range of distances is not adjacent to the third range of distances and the second range of distances is not adjacent to a fourth range of distances, and the first concentration is different to the second concentration.

The print agent distributor 302 is to apply fusing agent to build material based on the print data. In some examples, the print agent distributor 302 and the controller 304 are similar or identical to the print agent distributor 102 and controller 104 respectively described above with reference to FIG. 1.

The apparatus 300 also includes a fuser 306 to cause the portions of build material having the first, second, third and fourth ranges of distances to fuse to form the solid part of the object. For example, the fuser may be a radiation source (e.g. heat source) to apply radiation to the layer of build material. Portions of build material having the first and third ranges of distances may absorb sufficient radiation from the fuser 306 to cause those portions of build material to melt and subsequently solidify (e.g. following cooling) to be included within the solid part of the object. In some examples, portions of build material having the second and fourth ranges of distances may not absorb sufficient radiation directly from the fuser 306 to cause those portions of build material to melt and subsequently solidify (e.g. following cooling) to be included within the solid part of the object. However, these portions may absorb heat through conduction from adjacent portions (e.g. the portions of build material having the first and third ranges of distances) such that heat absorbed through conduction, and also any heat absorbed directly from the fuser 306 such that the portions melt and subsequently solidify (e.g. following cooling) to be included within the solid part of the object,

In some examples, the distance of each portion of build material from the edge of the object comprises the distance of each portion of build material from one of a nearest edge of the object and a nearest edge of the object in the layer of build material. Where the distance is to the nearest edge of the object in the layer of build material, the controller 304 may in some examples determine a layout and concentrations of fusing agent to be applied to the layer of build material based on a slice of the solid part of the object to be manufactured,

In some examples, the print data is to cause the print agent distributor to apply fusing agent to portions of build material having the first and third ranges of distances at the first range of concentrations and to portions of build material having the second and fourth ranges of distances at the second range of concentrations by applying fusing agent to portions of build material having the first and third ranges of distances at a first contone level and to portions of build material having the second and fourth ranges of distances at a second contone level. Thus, for example, the concentration of fusing agent between portions of build material may be varied by varying the contone level (e.g. the size of drops or dots of fusing agent applied to portions of build material by the print agent distributor 302) and/or varying the number of drops or dots of fusing agent applied to each addressable location (e.g. the fusing agent drop number density).

In some examples, the print data is to cause the print agent distributor to apply fusing agent to portions of build material having the second and fourth ranges of distances at the second mime of concentrations by applying no fusing agent to portions of build material having the second and fourth ranges of distances. Thus, in some examples, rings, paths or bands of fusing agent are applied at a first range of concentrations, separated by areas where no fusing agent is applied. These areas with no fusing agent may still solidify and be included in the solid part of the object, for example due to conduction of heat from adjacent areas.

In some examples, application of fusing agent to build material may change the appearance of the build material. Therefore, in some examples, applying fusing agent to some portions of build material at the first concentration and to other portions at the second concentration may be visible, at least during an additive manufacturing process in some examples. Therefore, in some examples, coloring agent (e.g. ink) is applied (e.g. by the print agent distributor 302 or another distributor) to portions of build material to mask the differences that would otherwise be visible. For example, the apparatus 300 is to apply coloring agent to portions of build material having the first and third ranges of distances; and/or the apparatus 300 is to apply coloring agent to portions of build material having the second and fourth ranges of distances.

FIG. 4 shows an example of a non-transitory machine-readable medium 400 comprising instructions 402 that, when executed by a processor 404, cause the processor 404 to, in response to a representation of a solid part of a 3D object or item to be manufactured, generate 406 instructions to cause an additive manufacturing device to apply fusing agent to a first region of build material according to a first density and to a second region of build material adjacent to the first region according to a second density different to the first density. In some examples, the second density is less than the first density and in some examples the second density is zero (i.e. no fusing agent is applied to the second region).

The instructions 402 also comprise instructions that, when executed by a processor 404, cause the processor 404 to generate 406 instructions to cause an additive manufacturing device to generate a solid part of an item, the instructions identifying a plurality of voxels comprising a representation of the solid part of the item and identifying an amount of fusing agent to be applied to portions of a layer of build material based on a depth of the corresponding voxel within the representation of the solid part of the item such that an amount of fusing agent within a first range is to be applied to portions of build material at first and second non-contiguous spans of depths and an amount of fusing agent within a second range lower than the first range is to be applied to portions of build material at third and fourth non-contiguous spans of depths

In some examples, therefore, the instructions 402 cause the processor 404 to generate instructions to apply an amount of fusing agent within the first range to areas of build material (e.g. in a layer of build material) that tend to form concentric rings, bands or paths, and/or to apply an amount of fusing agent within the second range to areas of build material (e.g in a layer of build material) that tend to form concentric rings, bands or paths. In some examples, the second range is zero, such that the instructions indicate that no fusing agent should be applied to those areas. Therefore, the areas of build material to which an amount of fusing agent within the first range is applied may in some examples be separated by areas of build material to which no fusing agent is applied. In some examples, subsequent fusing (e.g, due to the application of heat) may cause the areas of build material to which an amount of fusing agent is applied within both the first and second ranges may fuse to form the solid part of the item.

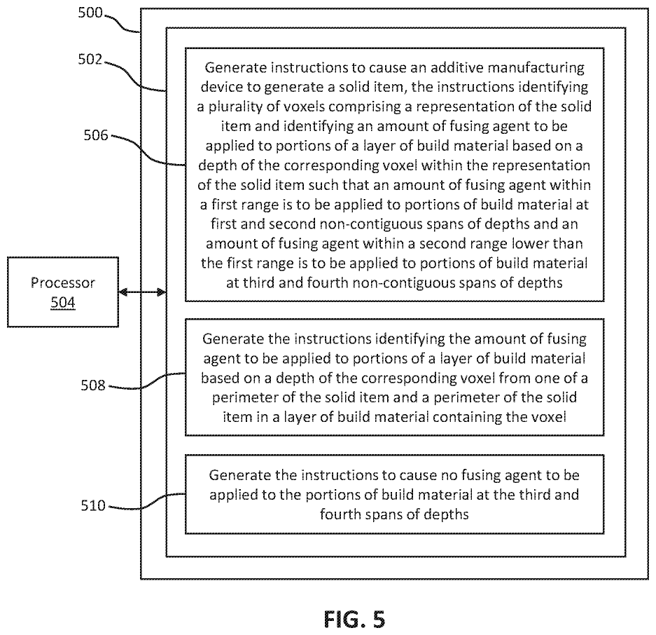

FIG. 5 shows an example of a non-transitory machine-readable medium 500 comprising instructions 502 that, when executed by a processor 504, cause the processor 504 to generate 506 instructions to cause an additive manufacturing device to generate a solid part of an item, the instructions identifying a plurality of voxels comprising a representation of the solid part of the item and identifying an amount of fusing agent to be applied to portions of a layer of build material based on a depth of the corresponding voxel within the representation of the solid part of the item such that an amount of fusing agent within a first range is to be applied to portions of build material at first and second non-contiguous spans of depths and an amount of fusing agent within a second range lower than the first range is to be applied to portions of build material at third and fourth non-contiguous spans of depths. In some examples, the generating 506 is similar or identical to the generating 406 caused by the instructions 402 described above with respect to FIG. 4.

The instructions 502 also include instructions that, when executed by the processor 504, cause the processor 504 to generate 508 the instructions identifying the amount of fusing agent to be applied to portions of a layer of build material based on a depth of the corresponding voxel from one of a perimeter of the solid part of the item and a perimeter of the solid part of the item in a layer of build material containing the voxel, Thus, for example, the distance could be the shortest distance between the voxel and any perimeter of the solid part of the item, or the shortest distance between the voxel and any perimeter within the layer of build material.

The instructions 502 also include instructions that, when executed by the processor 504, cause the processor 504 to generate 510 the instructions to cause no fusing agent to be applied to the portions of build material at the third and fourth spans of depths. Therefore, for example, the second range is zero fusing agent,

In some examples, the amount of fusing agent within the first range comprises a first amount of fusing agent, and the amount of fusing agent within the second range comprises a second amount of fusing agent. Therefore, for example, a particular amount (e.g. a particular concentration or density) of fusing agent is applied to each corresponding voxel location at the first and second non-contiguous spans of depths, and a lower amount (which may in some examples be zero) is applied to each corresponding voxel location at the third and fourth non-contiguous spans of depths.

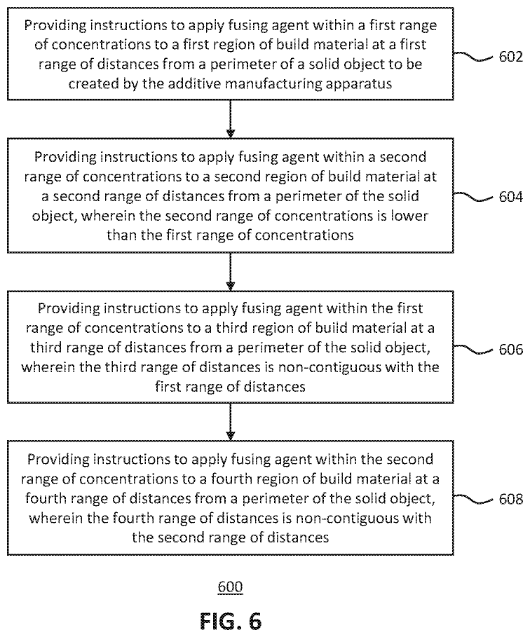

FIG. 6 is a flow chart of a method 600 of providing instructions for an additive manufacturing apparatus to create a solid part of an article. The method 600 comprises, in block 602, providing instructions to apply fusing agent within a first range of concentrations to a first region of build material at a first range of distances from a perimeter of a solid part of an article to be created by the additive manufacturing apparatus, and in block 604, providing instructions to apply fusing agent within a second range of concentrations to a second region of build material at a second range of distances from a perimeter of the solid part of the article. The second range of concentrations is lower than the first range of concentrations.

The method 600 also comprises, in block 606, providing instructions to apply fusing agent within the first range of concentrations to a third region of build material at a third range of distances from a perimeter of the solid part of the article, wherein the third range of distances is non-contiguous with the first range of distances, and in block 608, providing instructions to apply fusing agent within the second range of concentrations to a fourth region of build material at a fourth range of distances from a perimeter of the solid part of the article, wherein the fourth range of distances is non-contiguous with the second range of distances,

Thus in some examples the instructions may cause an additive manufacturing apparatus to apply fusing agent to build material (e.g. a layer of build material) in a manner that may tend to form concentric bands, rings or paths of alternating regions with the first range of concentrations and second ranges of concentrations. For example, regions with the first range of concentrations may be separated by a region with the second range of concentrations. So, for example, the first and third regions may be separated by the second or fourth region, and/or the second and fourth region may be separated by the first or third region. Once the regions of build material undergo a fusing process, the first, second, third and fourth regions of build material may fuse to form the solid part of the article, despite the lower concentration of fusing agent in the second and fourth regions.

In some examples, the method 600 comprises applying coloring agent to the first and third regions of build material, and/or to the second and fourth regions of build material. For example, the coloring agent (e.g. ink) may be applied to mask the appearance of the different regions of build material having different concentrations of fusing agent, if for example the different concentrations of fusing agent results in different appearance of regions of build material,

In some examples, providing instructions to apply fusing agent within the second range of concentrations to the second and fourth regions of build material comprises providing instructions to apply no fusing agent to the second and fourth regions of build material. Therefore, the second range of concentrations comprises zero fusing agent, for example.

In some examples, the first range of concentrations comprises a first concentration, and the second range of concentrations comprises a second concentration.

In some examples, by applying fusing agent to different regions that will form a part of an object or article at different concentrations (including zero concentration in some regions in some examples), heat absorbed or generated by the part of the object such as a solid part during a fusing process may be reduced compared to the case where the same concentration of fusing agent is applied to all of the regions that will form the part of the object.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Additive manufacturing apparatus comprising:
a print agent distributor; and
a controller to define print data for additive manufacture of a solid part of an object to be manufactured, wherein the print data is to cause a print agent distributor to apply fusing agent to portions of a layer of build material, wherein the print data is to cause a print agent distributor to apply fusing agent to portions of a layer of build material at a concentration based on a distance of each portion of build material from an edge of the solid part of the object such that the print data causes the print agent distributor to apply fusing agent to portions of a layer of build material having a first range of distances at a first range of concentrations, apply fusing agent to portions of build material having a second range of distances at a second range of concentrations lower than the first range of concentrations, apply fusing agent to portions of build material having a third range of distances at the first range of concentrations and apply fusing agent to portions of build material having a fourth range of distances at the second range of concentrations, wherein the first range of distances is not adjacent to the third range of distances and the second range of distances is not adjacent to a fourth range of distances, and the first concentration is different to the second concentration;
wherein the print agent distributor is to apply fusing agent to build material based on the print data.

2. The apparatus of claim 1, wherein the distance of each portion of build material from the edge of the object comprises the distance of each portion of build material from one of a nearest edge of the object and a nearest edge of the object in the layer of build material.

3. The apparatus of claim 1, further comprising a fuser to cause the portions of build material having the first, second, third and fourth ranges of distances to fuse to form the solid part of the object.

4. The apparatus of claim 1, wherein the print data is to cause the print agent distributor to apply fusing agent to portions of build material having the first and third ranges of distances at the first range of concentrations and to portions of build material having the second and fourth ranges of distances at the second range of concentrations by applying fusing agent to portions of build material having the first and third ranges of distances at a first contone level and to portions of build material having the second and fourth ranges of distances at a second contone level.

5. The apparatus of claim 1, wherein the print data is to cause the print agent distributor to apply fusing agent to portions of build material having the second and fourth ranges of distances at the second range of concentrations by applying no fusing agent to portions of build material having the second and fourth ranges of distances.

6. The apparatus of claim 1, wherein the apparatus is to apply coloring agent to portions of build material having the first and third ranges of distances.

7. The apparatus of claim 1, wherein the apparatus is to apply coloring agent to portions of build material having the second and fourth ranges of distances.

8. A non-transitory machine-readable medium comprising instructions that, when executed by a processor, cause the processor to:
generate instructions to cause an additive manufacturing device to generate a solid part of an item, the instructions identifying a plurality of voxels comprising a representation of the solid part of the item and identifying an amount of fusing agent to be applied to portions of a layer of build material based on a depth of the corresponding voxel within the representation of the solid part of the item such that an amount of fusing agent within a first range is to be applied to portions of build material at first and second non-contiguous spans of depths and an amount of fusing agent within a second range lower than the first range is to be applied to portions of build material at third and fourth non-contiguous spans of depths.

9. The machine-readable medium of claim 8, comprising instructions that, when executed by a processor, cause the processor to generate the instructions identifying the amount of fusing agent to be applied to portions of a layer of build material based on a depth of the corresponding voxel from one of a perimeter of the solid part of the item and a perimeter of the solid part of the item in a layer of build material containing the voxel.

10. The machine-readable medium of claim 8, comprising instructions that, when executed by a processor, cause the processor to generate the instructions to cause no fusing agent to be applied to the portions of build material at the third and fourth spans of depths.

11. The machine-readable medium of claim 8, wherein the amount of fusing agent within the first range comprises a first amount of fusing agent, and the amount of fusing agent within the second range comprises a second amount of fusing agent.

12. A method of providing instructions for an additive manufacturing apparatus to create a solid part of an article, the method comprising:
providing instructions to apply fusing agent within a first range of concentrations to a first region of build material at a first range of distances from a perimeter of a solid part of the article to be created by the additive manufacturing apparatus;
providing instructions to apply fusing agent within a second range of concentrations to a second region of build material at a second range of distances from a perimeter of the solid part of the article, wherein the second range of concentrations is lower than the first range of concentrations;
providing instructions to apply fusing agent within the first range of concentrations to a third region of build material at a third range of distances from a perimeter of the solid part of the article, wherein the third range of distances is non-contiguous with the first range of distances; and
providing instructions to apply fusing agent within the second range of concentrations to a fourth region of build material at a fourth range of distances from a perimeter of the solid part of the article_{;} wherein the fourth range of distances is non-contiguous with the second range of distances.

13. The method of claim 12, comprising applying coloring agent to one of:
the first and third regions of build material; and
the second and fourth regions of build material.

14. The method of claim 12, wherein providing instructions to apply fusing agent within the second range of concentrations to the second and fourth regions of build material comprises providing instructions to apply no fusing agent to the second and fourth regions of build material.

15. The method of claim 12, wherein the first range of distances is larger than one of the second, third and fourth ranges of distances.
